(19) United States
(12) Patent Application Publication
(10) Pub. No.: US 2025/0124292 A1
(43) Pub. Date: Apr. 17, 2025

(54) METHOD AND SYSTEM TO TRAIN AUDIO RETRIEVAL AND ZERO SHOT CLASSIFICATION SYSTEMS WITH COUNTER-FACTUAL PROMPTS

(71) Applicant: Robert Bosch GmbH, Stuttgart (DE)

(72) Inventors: Luca BONDI, Pittsburgh, PA (US); Mohammad Ali VOSOUGHI, Rochester, NY (US); Ho-Hsiang WU, Morrisville, NC (US); Samarjit DAS, Wexford, PA (US)

(21) Appl. No.: 18/379,518

(22) Filed: Oct. 12, 2023

(51) Int. Cl. G06N 3/084

(52) U.S. Cl. CPC G06N 3/084

(57) ABSTRACT

A method of machine learning network includes receiving one or more sound segments and one or more associated text labels indicating captions associated with the sound segments, generating, utilizing a large language model of the machine learning network, one or more counterfactual captions associated with the one or more sound segments, wherein the one or more counterfactual captions are adversarial captions, determining a loss associated with the one or more sound segments, one or more associated text labels, and one or more counterfactual captions, updating parameters associated with an audio encoder or text encoder of the machine learning network, in response to falling below a threshold, repeating steps list above, and in response to meeting the threshold and utilizing a ranking, updating final parameters associated with the machine learning network.

### TECHNICAL FIELD

The present disclosure relates to neural networks and machine learning, including those that utilize foundational models.

### BACKGROUND

Traditional machine learning models for audio processing are limited by predefined categories and independent classification tasks, hindering their potential for open-ended and adaptive audio understanding. Emerging trends in audio modeling aim to overcome these limitations by adopting more open-ended approaches that leverage the perception and reasoning abilities of foundational models, enabling adaptive and context-aware audio processing beyond predefined categories. Sound retrieval and zero-shot classification, where a model can make predictions on unseen audio using only textual descriptions, require learning the relationships between audio and language semantics. These approaches require human annotated audio captioning data, which is time-consuming and costly to acquire.

The exploration of audio-text representations is another relevant area of research. CLAP (Contrastive Language Audio Pretraining) introduces a method for jointly learning audio and text representations. Wav2CLIP extends the CLIP framework to the audio domain, enabling audio-visual understanding. AudioCLIP focuses on learning multimodal representations of audio and text, facilitating tasks such as audio captioning, sound localization, and audio-visual retrieval.

### SUMMARY

According to a first embodiment, a method of machine learning network includes receiving one or more sound segments that includes one or more associated text labels indicating captions, generating, utilizing a large language model of the machine learning network, one or more counterfactual captions associated with the one or more sound segments, wherein the one or more counterfactual captions are adversarial captions, determining a factual loss utilizing the one or more audio segments and the one or more associated text labels, determining an angle loss by adding a first loss and a second loss, wherein the first loss is associated with similarities of the one or more sound segments and the one or more associated text labels, and the second loss is associated with similarities of the one or more sound segments and the counterfactual captions, determining an aggregate loss by adding the factual loss and the angle loss, updating parameters associated with an audio encoder or text encoder of the machine learning network, in response to falling below a threshold repeating the above mention steps, and in response to meeting the threshold, updating final parameters associated with the machine learning network.

According to a second embodiment, a system for training at least one machine learning model is disclosed with a processor and a memory including instructions that, when execute by the processor, cause the processor to receive one or more sound segments that includes one or more associated text labels indicating captions; generate, utilizing a large language model of a machine learning network, one or more counterfactual captions associated with the one or more sound segments, wherein the one or more counterfactual captions are adversarial captions; determine a factual loss in response to a distance between the one or more audio segments and the one or more associated text labels; determine an angle loss by adding a first loss and a second loss, wherein the first loss is associated with cosine similarities of the one or more sound segments and the one or more associated text labels, and the second loss is associated with cosine similarities of the one or more sound segments and the counterfactual captions; determine an aggregate loss by aggregating the factual loss and the angle loss; update parameters associated with the machine learning network; in response to falling below a threshold, repeating the above mentioned steps, and in response to meeting the threshold and ranking the one or more sound segments, update final parameters associated with the machine learning network.

According to a third embodiment, a method of machine learning network includes receiving one or more sound segments and one or more associated text labels indicating captions associated with the sound segments, generating, utilizing a large language model of the machine learning network, one or more counterfactual captions associated with the one or more sound segments, wherein the one or more counterfactual captions are adversarial captions, determining a loss associated with the one or more sound segments, one or more associated text labels, and one or more counterfactual captions, updating parameters associated with an audio encoder or text encoder of the machine learning network, in response to falling below a threshold, repeating steps list above, and in response to meeting the threshold and utilizing a ranking, updating final parameters associated with the machine learning network.

### BRIEF DESCRIPTION OF THE DRAWINGS

FIG. 1 shows a system for training a neural network, according to an embodiment.

FIG. 2 shows a computer-implemented method for training and utilizing a neural network, according to an embodiment.

FIG. 3 illustrates a block diagram according to an embodiment of machine learning network utilizing counterfactual captions.

FIG. 4A illustrates an exemplary flow chart associated with an embodiment of the system and method that includes data generation and training pipeline.

FIG. 4B illustrates an exemplary flow chart associated with an embodiment of the system and method that includes a ranking pipeline.

FIG. 5 depicts a schematic diagram of an interaction between a computer-controlled machine and a control system, according to an embodiment.

FIG. 6 depicts a schematic diagram of the control system of FIG. 5 configured to control a vehicle, which may be a partially autonomous vehicle, a fully autonomous vehicle, a partially autonomous robot, or a fully autonomous robot, according to an embodiment.

FIG. 7 depicts a schematic diagram of the control system of FIG. 5 configured to control a manufacturing machine, such as a punch cutter, a cutter or a gun drill, of a manufacturing system, such as part of a production line.

FIG. 8 depicts a schematic diagram of the control system of FIG. 5 configured to control a power tool, such as a power drill or driver, that has an at least partially autonomous mode.

FIG. 9 depicts a schematic diagram of the control system of FIG. 5 configured to control an automated personal assistant.

FIG. 10 depicts a schematic diagram of the control system of FIG. 5 configured to control a monitoring system, such as a control access system or a surveillance system.

FIG. 11 depicts a schematic diagram of the control system of FIG. 5 configured to control an imaging system, for example an MRI apparatus, x-ray imaging apparatus or ultrasonic apparatus.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

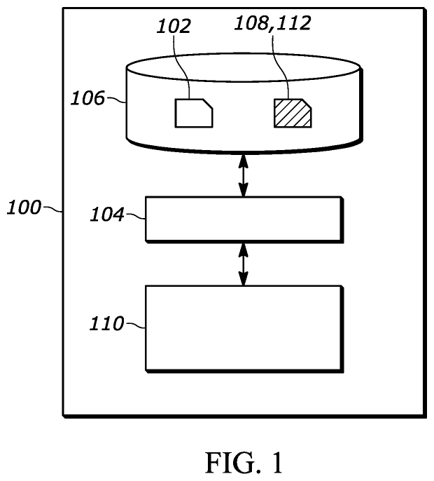

Reference is now made to the embodiments illustrated in the Figures, which can apply these teachings to a machine learning model or neural network. FIG. 1 shows a system 100 for training a neural network, e.g. a deep neural network. The system 100 may comprise an input interface for accessing training data 102 for the neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, Zigbee or Wi-Fi interface or an ethernet or fiberoptic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the neural network which may be accessed by the system 100 from the data storage 106. It will be appreciated, however, that the training data 102 and the data representation 108 of the untrained neural network may also each be accessed from a different data storage, e.g., via a different subsystem of the data storage interface 104. Each subsystem may be of a type as is described above for the data storage interface 104. In other embodiments, the data representation 108 of the untrained neural network may be internally generated by the system 100 on the basis of design parameters for the neural network, and therefore may not explicitly be stored on the data storage 106. The system 100 may further comprise a processor subsystem 110 which may be configured to, during operation of the system 100, provide an iterative function as a substitute for a stack of layers of the neural network to be trained. Here, respective layers of the stack of layers being substituted may have mutually shared weights and may receive as input an output of a previous layer, or for a first layer of the stack of layers, an initial activation, and a part of the input of the stack of layers. The processor subsystem 110 may be further configured to iteratively train the neural network using the training data 102. Here, an iteration of the training by the processor subsystem 110 may comprise a forward propagation part and a backward propagation part. The processor subsystem 110 may be configured to perform the forward propagation part by. amongst other operations defining the forward propagation part which may be performed, determining an equilibrium point of the iterative function at which the iterative function converges to a fixed point, wherein determining the equilibrium point comprises using a numerical root-finding algorithm to find a root solution for the iterative function minus its input, and by providing the equilibrium point as a substitute for an output of the stack of layers in the neural network. The system 100 may further comprise an output interface for outputting a data representation 112 of the trained neural network, this data may also be referred to as trained model data 112. For example, as also illustrated in FIG. 1, the output interface may be constituted by the data storage interface 104, with said interface being in these embodiments an input/output (‘IO’) interface, via which the trained model data 112 may be stored in the data storage 106. For example, the data representation 108 defining the ‘untrained’ neural network may during or after the training be replaced, at least in part by the data representation 112 of the trained neural network, in that the parameters of the neural network, such as weights, hyperparameters and other types of parameters of neural networks, may be adapted to reflect the training on the training data 102. This is also illustrated in FIG. 1 by the reference numerals 108, 112 referring to the same data record on the data storage 106. In other embodiments, the data representation 112 may be stored separately from the data representation 108 defining the ‘untrained’ neural network. In some embodiments, the output interface may be separate from the data storage interface 104, but may in general be of a type as described above for the data storage interface 104.

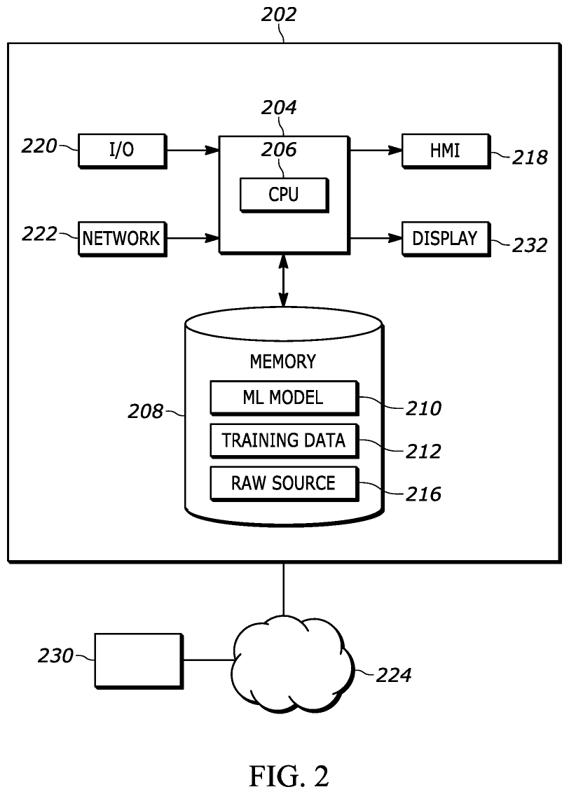

The structure of the system 100 is one example of a system that may be utilized to train a pre-trained machine learning network that utilizes zero-shot audio learning described herein. Additional structure for operating and training the machine-learning models is shown in FIG. 2.

FIG. 2 depicts a system to implement the machine-learning models described herein, for example the pre-trained machine learning network that utilizes zero-shot audio learning described herein. The system 200 can be implemented to perform zero-shot audio learning described herein. The system 200 may include at least one computing system 202. The computing system 202 may include at least one processor 204 that is operatively connected to a memory unit 208. The processor 204 may include one or more integrated circuits that implement the functionality of a central processing unit (CPU) 206. The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The processor may include a controller, tensor processing unit, graphics processing unit, ASIC, FPGA, etc. The computing system 202 may implement an operating system for managing various aspects of the operation. While one processor 204, one CPU 206, and one memory 208 is shown in FIG. 2, of course more than one of each can be utilized in an overall system.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine-learning model 210 or algorithm, a training dataset 212 for the machine-learning model 210, raw source dataset 216.

The computing system 202 may include a network interface device 222 that is configured to provide communication with external systems and devices. For example, the network interface device 222 may include a wired and/or wireless Ethernet interface as defined by Institute of Electrical and Electronics Engineers (IEEE) 802.11 family of standards. The network interface device 222 may include a cellular communication interface for communicating with a cellular network (e.g., 3G, 4G, 5G). The network interface device 222 may be further configured to provide a communication interface to an external network 224 or cloud.

The external network 224 may be referred to as the world-wide web or the Internet. The external network 224 may establish a standard communication protocol between computing devices. The external network 224 may allow information and data to be easily exchanged between computing devices and networks. One or more servers 230 may be in communication with the external network 224.

The computing system 202 may include an input/output (I/O) interface 220 that may be configured to provide digital and/or analog inputs and outputs. The I/O interface 220 is used to transfer information between internal storage and external input and/or output devices (e.g., HMI devices). The I/O 220 interface can includes associated circuity or BUS networks to transfer information to or between the processor(s) and storage. For example, the I/O interface 220 can include digital I/O logic lines which can be read or set by the processor(s), handshake lines to supervise data transfer via the I/O lines; timing and counting facilities, and other structure known to provide such functions. Examples of input devices include a keyboard, mouse, sensors, etc. Examples of output devices include monitors, printers, speakers, etc. The I/O interface 220 may include additional serial interfaces for communicating with external devices (e.g., Universal Serial Bus (USB) interface).

The computing system 202 may include a human-machine interface (HMI) device 218 that may include any device that enables the system to receive control input. Examples of input devices may include human interface inputs such as keyboards, mice, touchscreens, voice input devices, and other similar devices. The computing system 202 may include a display device 232. The computing system 202 may include hardware and software for outputting graphics and text information to the display device 232. The display device 232 may include an electronic display screen, projector, printer or other suitable device for displaying information to a user or operator. The computing system 202 may be further configured to allow interaction with remote HMI and remote display devices via the network interface device 222.

The system may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

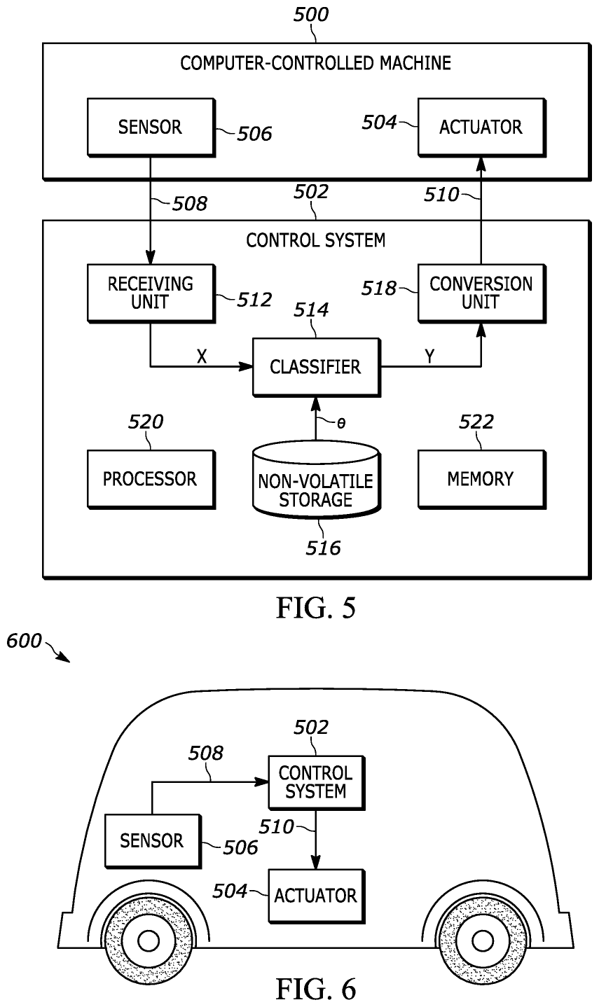

The system may implement a machine-learning algorithm 210 that is configured to analyze the raw source dataset 216. The raw source dataset 216 may include raw or unprocessed sensor data that may be representative of an input dataset for a machine-learning system. The raw source dataset 216 may include video, video segments, images, text-based information, audio or human speech, time series data (e.g., a pressure sensor signal over time), and raw or partially processed sensor data (e.g., radar map of objects). In embodiment described with respect to the current disclosure, they may be audio-related datasets. Several different examples of inputs are shown and described with reference to FIGS. 5-11. In some examples, the machine-learning algorithm 210 may be a neural network algorithm (e.g., deep neural network) that is designed to perform a predetermined function. For example, the neural network algorithm may be configured in automotive applications to identify street signs or pedestrians in images, sirens and honk sounds in audio. The machine-learning algorithm(s) 210 may include algorithms configured to operate the pre-trained machine learning network that utilizes zero-shot or few-shot audio learning described herein.

The computer system may store a training dataset 212 for the machine-learning algorithm 210. The training dataset 212 may represent a set of previously constructed data for training the machine-learning algorithm 210. The training dataset 212 may be used by the machine-learning algorithm 210 to learn weighting factors associated with a neural network algorithm. The training dataset 212 may include a set of source data that has corresponding outcomes or results that the machine-learning algorithm 210 tries to duplicate via the learning process. In this example, the training dataset 212 may include input audio that include a sound (e.g., siren wailing, car honking). The input audio may include various scenarios in which the sounds are identified.

The machine-learning algorithm 210 may be operated in a learning mode using the training dataset 212 as input. The machine-learning algorithm 210 may be executed over a number of iterations using the data from the training dataset 212. With each iteration, the machine-learning algorithm 210 may update internal weighting factors based on the achieved results. For example, the machine-learning algorithm 210 can compare output results (e.g., a reconstructed or supplemented image, in the case where image data is the input) with those included in the training dataset 212. Since the training dataset 212 includes the expected results, the machine-learning algorithm 210 can determine when performance is acceptable. After the machine-learning algorithm 210 achieves a predetermined performance level (e.g., 100% agreement with the outcomes associated with the training dataset 212), or convergence, the machine-learning algorithm 210 may be executed using data that is not in the training dataset 212. It should be understood that in this disclosure, “convergence” can mean a set (e.g., predetermined) number of iterations have occurred, or that the residual is sufficiently small (e.g., the change in the approximate probability over iterations is changing by less than a threshold), or other convergence conditions. The trained machine-learning algorithm 210 may be applied to new datasets to generate annotated data.

The machine-learning algorithm 210 may be configured to identify a particular feature in the raw source data 216. The raw source data 216 may include a plurality of instances or input dataset for which supplementation results are desired. For example, the machine-learning algorithm 210 may be configured to identify the presence of a road sign in video images and annotate the occurrences. In another example, the machine-learning algorithm 10 may be configured to identify a certain sound from an audio file. The machine-learning algorithm 210 may be programmed to process the raw source data 216 to identify the presence of the particular features. The machine-learning algorithm 210 may be configured to identify a feature in the raw source data 216 as a predetermined feature (e.g., road sign). The raw source data 216 may be derived from a variety of sources. For example, the raw source data 216 may be actual input data collected by a machine-learning system. The raw source data 216 may be machine generated for testing the system. As an example, the raw source data 216 may include raw audio from a microphone.

In an example, the raw source data 216 may include image data representing an image. Applying the machine-learning algorithms (e.g., CLAP, Wav2CLIP, AudioCLIP, few-shot image learning, CLIP models, etc.) described herein, the output can be a tuned network associated with a set of images.

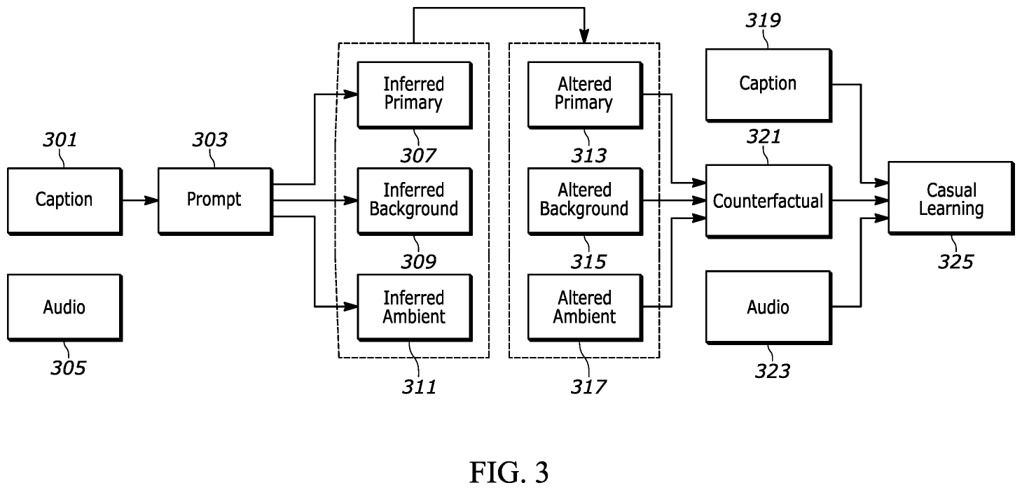

FIG. 3 discloses an overview diagram of generating counterfactual captions and learning associated with such a system. Causality may refer to the relationship between events, where one event, the cause, brings about another event, the effect. In this disclosure, causality may be utilized in the field of sound and captioned description, where producing counterfactual sound is impossible or difficult, the system and method may utilize natural language for this purpose.

Techniques that enhance model performance and robustness through natural language augmentation exist. These methodologies produce artificial variations of textual data to ensure models generalize across varied inputs. With the introduction of causal reasoning in large language models, there is a newfound capability to introspect causal relationships and engage in causal counterfactual reasoning. The system and method described below may utilize a hypothetical intervention on the observed caption y given a prompt p, denoted as y*=f(y|p), to generate counterfactual variations. The prompt p may embody three key aspects: grounding in facts to avoid hallucinations, identification of acoustic sources from captions, and altering captions through manipulation on the sources of the acoustics. An example of prompting is represented in Table 2. A few instances of the original captions and counterfactuals are shown in Table 1, set forth below.

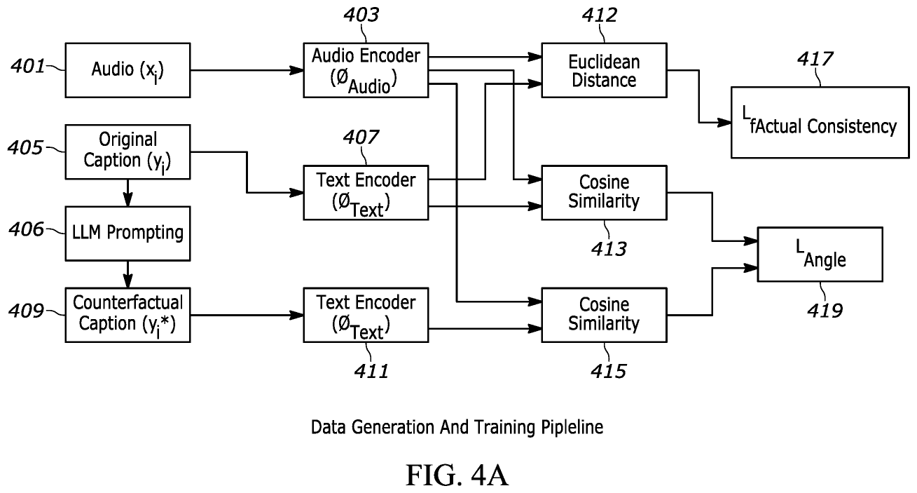

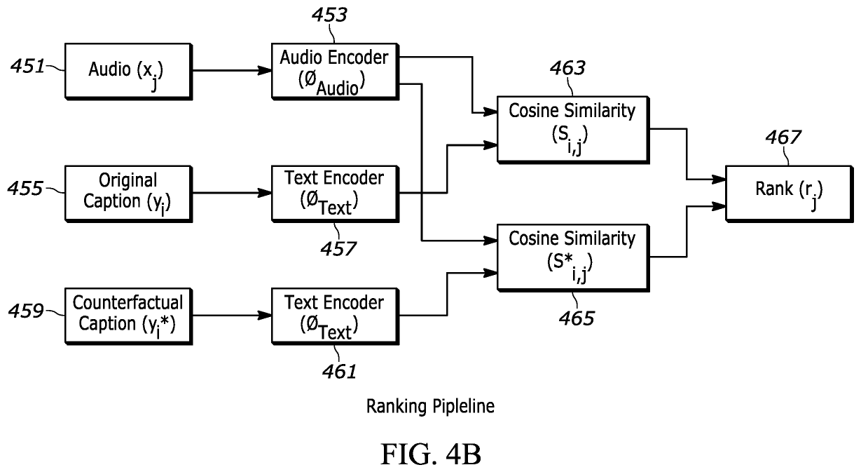

The proposed training technique may utilize a combination of two components: factual consistency loss and angle loss. An overview of the training process is depicted in FIG. 4A. The audio encoder (Ø_{audio}) may be a neural network that takes as input an audio sample and produces as output a vector embedding of the sample. The weights of the audio encoder are updated via back-propagation during the training process.

The text encoder (Øₜₑₓₜ) may be a neural network that takes as input an text sequence and produces as output a vector embedding of the sequence. The weights of the text encoder are frozen during the training process.

This loss is for encouraging the audio to remain consistent with the factual captions, and it is defined as Equation 1 below:

$${L}_{factual \_ consistency} = \frac{1}{N} {\sum }_{i = 1}^{N} {‖ {∅}_{audio} ( {x}_{i} ) - {∅}_{text} ( {y}_{i} ) ‖}_{2}^{2}$$

To minimize the angle between the audio and the captions compared to the angle between the audio and the counterfactual captions, the system may define the angle loss as Equation 2 below:

$${L}_{angle} = \frac{1}{N} {\sum }_{i = 1}^{N} max ( 0 , cos ( {∅}_{audio} ( {x}_{i} ) , {∅}_{text} ( {y}_{i}^{*} ) ) - cos ( {∅}_{audio} ( {x}_{i} ) - {∅}_{text} ( {y}_{i} ) ) + μ )$$

where μ is the angular margin.

The total loss may be computed by aggregating the angle loss and the factual consistency loss. Finally, the aggregate loss is computed as Equation 3 below:

$${L}_{total} = {L}_{angle} + {L}_{factual \_ consistency}$$

In (Equation 3) the combination encapsulates relationships between factual and counterfactual captions for audio, while preserving factual text closer to audio as compared to counterfactual y* by prompt-based intervention p.

Once the audio encoder is trained, searching for audio contents in a large audio collection may follow the diagram as shown in FIG. 4B. The system may rank utilizing the general process outlined below. Thus, a system may be given an audio segment xⱼ; a set of N^{p} positive captions yᵢ, i∈[1, N^{p}]; a set of N^{c} counterfactual captions yᵢ, i∈[1, N^{c}], either defined manually or generated via LLM prompting.

The audio encoder Ø_{audio} may be trained with the above procedure, the same text encoder Øₜₑₓₜ used in the training procedure the system extract, the audio embedding Ø_{audio}(xⱼ) for the audio segment, the set of positive text embeddings Øₜₑₓₜ(yᵢ), i∈[1, N^{p}], the set of counterfactual text embeddings Øₜₑₓₜ(yᵢ*), i∈[1, N^{c}] then computes, the cosine similarity between all positive text embeddings and the segment s_{i,j}=cos(Øₜₑₓₜ(yᵢ), Ø_{audio}(xⱼ))), i∈[1, N^{p}], the cosine similarity between all counterfactual text embeddings and the segment

$${s}_{i , j}^{*} = cos ( {∅}_{text} ( {y}_{i}^{*} ) , {∅}_{audio} ( {x}_{j} ) ) , i ∈ [ 1 , {N}^{c} ]$$

finally, the rank for audio segment rⱼ may be computed as the sum of cosine similarities between all positive text embeddings and the segment minus the sum of cosine similarities between all counterfactual text embeddings and the segment, as per equation 4 below:

$${r}_{j} = {\sum }_{i = 1}^{{N}^{p}} {s}_{i , j} {\sum }_{i = 1}^{{N}^{c}} {s}_{i , j}^{*} \qquad ( Equation 4 )$$

Audio segments are then ranked by descending value of rⱼ, so that samples with higher rank are more relevant to the positive captions.

This loss is for encouraging the audio to remain consistent with the factual captions, and it may be defined in Table 1 as an example of original and counterfactual captions:

TABLE 1

| Dataset | Original Caption | Counterfactual Captions |
|---|---|---|
| Clotho | Fireworks in the sky | Gunshots in the sky |
| Clotho | Sunny day at the beach | Rainy day at the beach |
| Clotho | Delicious chocolate cake | Burnt chocolate cake |
| AudioCaps | Children playing in the park | Abandoned park |
| AudioCaps | Elegant Wedding Ceremony | Chaotic wedding ceremony |
| AudioCaps | Mountain peak covered in | Mountain peak covered in |
| | snow | lava |
| MACS | A calm river in the forest | Polluted river in the forest |
| MACS | Warm and cozy fireplace | Smoking fireplace |
| MACS | Adults talking and some | Adults talking and some |
| | footsteps coming across | footsteps coming across |

Such an approach may employ counterfactual reasoning techniques to distinguish various sound sources in an audio signal captured by a microphone. Utilizing a large language model, the system may identify and characterize such isolated sound sources. Subsequently, the system may manipulate the characterized sound to construct a simulated linguistic representation, thereby eliminating dependence on empirical audio data.

A caption 301 may be associated with or paired with an audio signal 305. The caption 301 may need a counterfactual caption for the present disclosure. Typically, the counterfactual caption may increase a loss in the audio signal 305 as compared to the original caption 301. For example, a sound of fireworks with a caption of “fireworks” may have less loss than the counterfactual caption of “gun shots.” At prompt 303 at a large language model (e.g. ChatGPT) may request for the counterfactual caption to be created by changing the original caption.

The LLM may utilize the original caption to generate the counterfactual caption. The LLM may analyze the caption and identify the interred primary source 307, inferred background 309, and inferred ambient 311. Thus, the model may analyze the inferred primary sound 307 and identify a “firework explosion” for example. Then, it may analyze the inferred background sound 309. In one example, this may include an environment of the firework explosion, such as “at the golf course.” Next, it may analyze the inferred ambient noise or sound 311. This may include ambient noise that should not be the primary noise associated with the signal. Thus, utilizing these portions of the sound, the system may work to generate a counterfactual caption.

For example, utilizing the inferred primary 307, the LLM may generate a caption that is opposite, different, or adversarial to the original caption. Thus, it may have an altered primary sound 313 for “fireworks” that may be “gunshot” or “thunder.” Utilizing the inferred background 309, the system may change the background of “park” to “city” in one example. Utilizing the inferred ambient noise, the model may change an ambient noise of “people talking” to “animals talking.” Once the system gathers the various portions for the counterfactual caption, it may generate a counterfactual caption 321. Then, the system may utilize the original caption 319, counterfactual caption 321, and audio 323 for casual learning 325. This may be done by determining various losses (as explained above) and analyzing various parameters to rank the audio segments.

FIG. 4A illustrates an exemplary flow chart associated with an embodiment of the system and method that includes data generation and training pipeline. The audio 401 may be sent to an audio encoder 403. The system may receive an audio signal 401 that includes one or more sound segments. The audio signal may be any type of audio signal that is captured from a sensor such as a microphone. The audio may be fed to an audio encoder 403 associated with a machine learning network. The audio encoder 403 may be associated with a pre-trained neural network for audio understanding, such as Pann, YamNet, CLAP, or AudioCLIP. The audio encoder 403 may work with a large language model (e.g., ChatGPT) that has associated parameters/weights. The audio encoder 403 may generate vectors/embeddings of encodings related to the associated sound.

The system may also receive original captions 405 associated with the audio signal/sound. The captions 405 may be reflective of a description associated with the audio signal. For example, the caption 405 may include a label that states “fireworks” for an associated sound of fireworks. The captions 405 may be fed to text encoder 407. The text encoder 407 may generate vectors/embeddings of encodings related to the associated label/text.

The system may receive one or more prompts at the large language model 406. The prompts may include a request to generate one or more counterfactual captions 409. The counterfactual captions 409 may be associated with the audio signal/sound. The counterfactual captions 409 may be reflective of an adversarial description associated with the audio signal. For example, the counterfactual captions 409 may include a label that states “gun shot” or “muffler” for a sound associated with fireworks. Thus, the counterfactual captions 409 may be considered negative captions or adversarial. The counterfactual captions 409 may be fed to the text encoder 411 (which may be the same text encoder as 407). The text encoder 411 may generate vectors/embeddings of encodings related to the adversarial label/text.

The audio encoder 403 may output one or more vectors associated with the audio signal. Likewise, the text encoder 407 may output one or more vectors associated with the original caption. The system may identify or determine a Euclidean distance 412 (or any other distance) between the vectors related to the audio signal and the vectors of the original caption. The distance (e.g. Euclidean distance 412) may be utilized to determine a loss 417, like a factual consistency loss. Such a loss may be defined by Equation 1:

$${L}_{factual \_ consistency} = \frac{1}{N} {\sum }_{i = 1}^{N} {‖ {∅}_{audio} ( {x}_{i} ) - {∅}_{text} ( {y}_{i} ) ‖}_{2}^{2}$$

The text encoder 407 may output one or more vectors associated with the original caption that is utilized to determine a cosine similarity 413 between the audio signal and original caption. The cosine similarity associated with the original caption may be utilized to find an angle loss. Furthermore, the cosine similarity 415 associated with the audio signal and the counterfactual caption vector may be utilized. The angle loss 419 may be utilized to minimize the angle between the audio and the captions compared to the angle between the audio and counter-factual captions.

FIG. 4B illustrates an exemplary flow chart associated with an embodiment of the system and method that includes a ranking pipeline. The system may receive an audio signal 451 that includes one or more sound segments. The audio signal may be any type of audio signal that is captured from a sensor such as a microphone. The audio may be fed to an audio encoder 453 associated with a machine learning network. The audio encoder 453 may be associated with a pre-trained neural network that has associated parameters/weights. The audio encoder 453 may generate vectors/embeddings of encodings related to the associated sound.

The system may also receive original captions 455 associated with the audio signal/sound. The captions 455 may be reflective of a description associated with the audio signal. For example, the caption 455 may include a label that states “fireworks” for an associated sound of fireworks. The captions 455 may be fed to text encoder 457. The text encoder 457 may generate vectors/embeddings of encodings related to the associated label/text.

The system may also utilize counterfactual captions 459. In one embodiment, the counterfactual captions 459 may be automatically generated. The counterfactual captions 459 may be associated with the audio signal/sound. The counterfactual captions 459 may be reflective of an adversarial description associated with the audio signal. For example, the counterfactual captions 459 may include a label that states “gun shot” or “muffler” for a sound associated with fireworks. Thus, the counterfactual captions 459 may be considered negative captions or adversarial. The counterfactual captions 459 may be fed to the text encoder 461 (which may be the same text encoder as 457). The text encoder 461 may generate vectors/embeddings of encodings related to the adversarial label/text.

The system may then find cosine similarities comparing the various sounds to the various embeddings that were derived from the text encoders and captions. The machine learning networks may output embeddings or vectors from the various encoders. For example, the cosine similarities 461 comparing the audio encodings and text encodings from the original captions may be generated.

Next the system may rank 467 the cosine similarities. This may determine which audio signal or sound is closest in similarities to the text. The parameters that create the best classification of sound may be selected as the final parameters. The text encoder or audio encoder may be updated based on those parameters.

FIG. 5 depicts a schematic diagram of an interaction between a computer-controlled machine 500 and a control system 502. Computer-controlled machine 500 includes actuator 504 and sensor 506. Actuator 504 may include one or more actuators and sensor 506 may include one or more sensors. Sensor 506 is configured to sense a condition of computer-controlled machine 500. Sensor 506 may be configured to encode the sensed condition into sensor signals 508 and to transmit sensor signals 508 to control system 502. Non-limiting examples of sensor 506 include video, radar, LiDAR, ultrasonic and motion sensors. Image data may be retrieved from these sensors, such as video images, picture images, radar images, sound images, etc. The images may represent video or picture data that may include a plurality of pixels that form a scene. A pixel may be the smallest addressable element in a raster image, or the smallest addressable element in a dot matrix display device. In most digital display devices, pixels may be the smallest element that can be manipulated through software. Each pixel may be a sample of an original or synthetic image. In one embodiment, more samples typically provide more accurate representations of the original. The intensity of each pixel may be variable. The sensors may include a microphone or another sensor configured to pick up sound. In one embodiment, sensor 506 is an optical sensor configured to sense optical images of an environment proximate to computer-controlled machine 500.

Control system 502 is configured to receive sensor signals 508 from computer-controlled machine 500. As set forth below, control system 502 may be further configured to compute actuator control commands 510 depending on the sensor signals and to transmit actuator control commands 510 to actuator 504 of computer-controlled machine 500.

As shown in FIG. 5, control system 502 includes receiving unit 512. Receiving unit 512 may be configured to receive sensor signals 508 from sensor 506 and to transform sensor signals 508 into input signals x. In an alternative embodiment, sensor signals 508 are received directly as input signals x without receiving unit 512. Each input signal x may be a portion of each sensor signal 508. Receiving unit 512 may be configured to process each sensor signal 508 to product each input signal x. Input signal x may include data corresponding to an image recorded by sensor 506.

Control system 502 includes a classifier 514. Classifier 514 may be configured to classify input signals x into one or more labels using a machine learning (ML) algorithm, such as a neural network described above. Classifier 514 is configured to be parametrized by parameters, such as those described above (e.g., parameter θ). Parameters θ may be stored in and provided by non-volatile storage 516. Classifier 514 is configured to determine output signals y from input signals x. Each output signal y includes information that assigns one or more labels to each input signal x. Classifier 514 may transmit output signals y to conversion unit 518. Conversion unit 518 is configured to covert output signals y into actuator control commands 510. Control system 502 is configured to transmit actuator control commands 510 to actuator 504, which is configured to actuate computer-controlled machine 500 in response to actuator control commands 510. In another embodiment, actuator 504 is configured to actuate computer-controlled machine 500 based directly on output signals y.

Upon receipt of actuator control commands 510 by actuator 504, actuator 504 is configured to execute an action corresponding to the related actuator control command 510. Actuator 504 may include a control logic configured to transform actuator control commands 510 into a second actuator control command, which is utilized to control actuator 504. In one or more embodiments, actuator control commands 510 may be utilized to control a display instead of or in addition to an actuator.

In another embodiment, control system 502 includes sensor 506 instead of or in addition to computer-controlled machine 500 including sensor 506. Control system 502 may also include actuator 504 instead of or in addition to computer-controlled machine 500 including actuator 504.

As shown in FIG. 5, control system 502 also includes processor 520 and memory 522. Processor 520 may include one or more processors. Memory 522 may include one or more memory devices. The classifier 514 (e.g., machine-learning algorithms, such as those described above with regard to the audio encoder or text encoder) of one or more embodiments may be implemented by control system 502, which includes non-volatile storage 516, processor 520 and memory 522.

Non-volatile storage 516 may include one or more persistent data storage devices such as a hard drive, optical drive, tape drive, non-volatile solid-state device, cloud storage or any other device capable of persistently storing information. Processor 520 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 522. Memory 522 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information.

Processor 520 may be configured to read into memory 522 and execute computer-executable instructions residing in non-volatile storage 516 and embodying one or more ML algorithms and/or methodologies of one or more embodiments. Non-volatile storage 516 may include one or more operating systems and applications. Non-volatile storage 516 may store compiled and/or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

Upon execution by processor 520, the computer-executable instructions of non-volatile storage 516 may cause control system 502 to implement one or more of the ML algorithms and/or methodologies as disclosed herein. Non-volatile storage 516 may also include ML data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

FIG. 6 depicts a schematic diagram of control system 502 configured to control vehicle 600, which may be an at least partially autonomous vehicle or an at least partially autonomous robot. Vehicle 600 includes actuator 504 and sensor 506. Sensor 506 may include one or more video sensors, cameras, radar sensors, ultrasonic sensors, LiDAR sensors, and/or position sensors (e.g. GPS). One or more of the one or more specific sensors may be integrated into vehicle 600. In the context of sign-recognition and processing as described herein, the sensor 506 is a camera mounted to or integrated into the vehicle 600. Alternatively or in addition to one or more specific sensors identified above, sensor 506 may include a software module configured to, upon execution, determine a state of actuator 504. One non-limiting example of a software module includes a sound information software module configured to determine a classification of sound emitted that is proximate vehicle 600 or other location.

Classifier 514 of control system 502 of vehicle 600 may be configured to detect objects in the vicinity of vehicle 600 dependent on input signals x. In such an embodiment, output signal y may include information characterizing the vicinity of objects to vehicle 600. Actuator control command 510 may be determined in accordance with this information. The actuator control command 510 may be used to avoid collisions with the detected objects, in one example.

In embodiments where vehicle 600 is an at least partially autonomous vehicle, actuator 504 may be embodied in a brake, a propulsion system, an engine, a drivetrain, or a steering of vehicle 600. Actuator control commands 510 may be determined such that actuator 504 is controlled such that vehicle 600 avoids collisions with detected objects. Detected objects may also be classified according to what classifier 514 deems them most likely to be, such as pedestrians or trees. The actuator control commands 510 may be determined depending on the classification. In one scenario, sound emitted surrounding vehicle 600 may be utilized to assess any faulty components of vehicle 600 or a scenario related to an eminent situation (e.g., another vehicle horn being honked).

In other embodiments where vehicle 600 is an at least partially autonomous robot, vehicle 600 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 510 may be determined such that a propulsion unit, steering unit and/or brake unit of the mobile robot may be controlled such that the mobile robot may be maneuvered or stopped based upon a sound.

In another embodiment, vehicle 600 is an at least partially autonomous robot in the form of a gardening robot. In such embodiment, vehicle 600 may use an optical sensor as sensor 506 to determine a state of plants in an environment proximate vehicle 600. Actuator 504 may be a nozzle configured to spray chemicals. Depending on an identified species and/or an identified state of the plants, actuator control command 510 may be determined to cause actuator 504 to spray the plants with a suitable quantity of suitable chemicals.

Vehicle 600 may be an at least partially autonomous robot in the form of a domestic appliance. Non-limiting examples of domestic appliances include a washing machine, a stove, an oven, a microwave, or a dishwasher. In such a vehicle 600, sensor 506 may be an optical sensor configured to detect a state of an object which is to undergo processing by the household appliance. For example, in the case of the domestic appliance being a washing machine, sensor 506 may detect a state of the laundry inside the washing machine. Actuator control command 510 may be determined based on the detected state of the laundry.

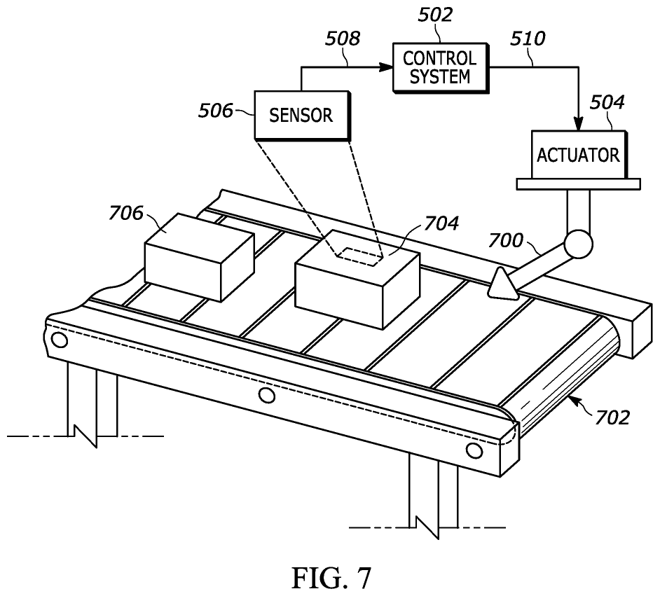

FIG. 7 depicts a schematic diagram of control system 502 configured to control system 700 (e.g., manufacturing machine), such as a punch cutter, a cutter or a gun drill, of manufacturing system 702, such as part of a production line. Control system 502 may be configured to control actuator 504, which is configured to control system 700 (e.g., manufacturing machine).

Sensor 506 of system 700 (e.g., manufacturing machine) may be an optical sensor configured to capture one or more properties of manufactured product 704. Classifier 514 may be configured to determine a state of manufactured product 704 from one or more of the captured properties, such as those based on the sound. Actuator 504 may be configured to control system 700 (e.g., manufacturing machine) depending on the determined state of manufactured product 704 for a subsequent manufacturing step of manufactured product 704. The actuator 504 may be configured to control functions of system 700 (e.g., manufacturing machine) on subsequent manufactured product 106 of system 700 (e.g., manufacturing machine) depending on the determined state of manufactured product 704.

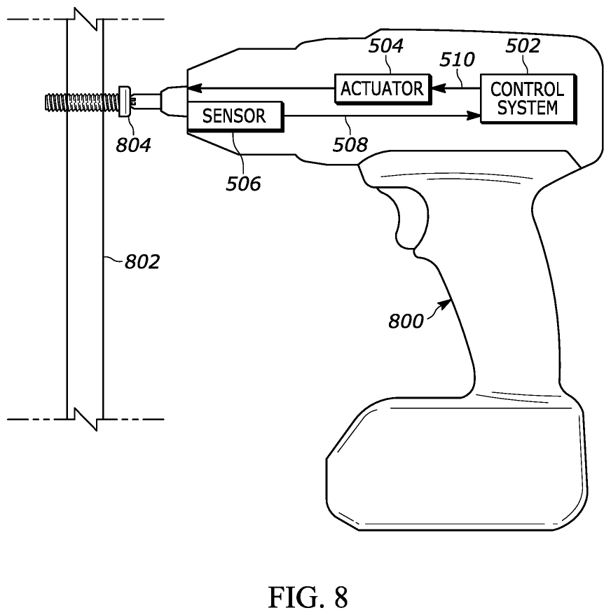

FIG. 8 depicts a schematic diagram of control system 502 configured to control power tool 800, such as a power drill or driver, that has an at least partially autonomous mode. Control system 502 may be configured to control actuator 504, which is configured to control power tool 800.

Sensor 506 of power tool 800 may be an optical sensor configured to capture one or more sounds based on drilling/fastening of work surface 802 and/or fastener 804 being driven into work surface 802. Classifier 514 may be configured to determine a state of work surface 802 and/or fastener 804 relative to work surface 802 from one or more of the captured properties. The state may be fastener 804 being flush with work surface 802. The state may alternatively be hardness of work surface 802. Actuator 504 may be configured to control power tool 800 such that the driving function of power tool 800 is adjusted depending on the determined state of fastener 804 relative to work surface 802 or one or more captured properties of work surface 802. For example, actuator 504 may discontinue the driving function if the state of fastener 804 is flush relative to work surface 802. As another non-limiting example, actuator 504 may apply additional or less torque depending on the hardness of work surface 802 in combination with a sound of the work surface.

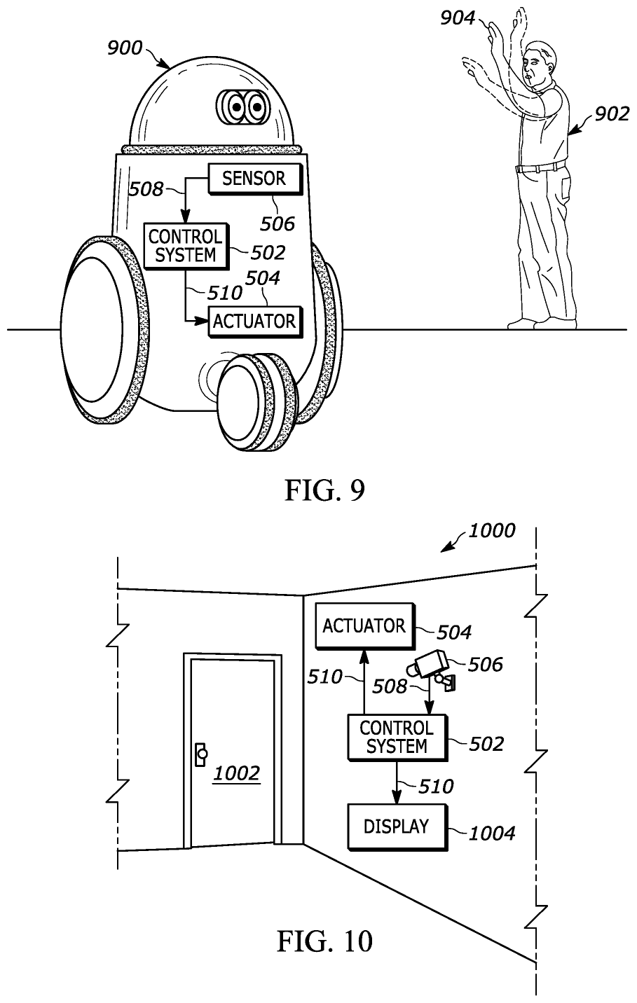

FIG. 9 depicts a schematic diagram of control system 502 configured to control automated personal assistant 900. Control system 502 may be configured to control actuator 504, which is configured to control automated personal assistant 900. Automated personal assistant 900 may be configured to control a domestic appliance, such as a washing machine, a stove, an oven, a microwave or a dishwasher.

Sensor 506 may be an optical sensor and/or an audio sensor. The optical sensor may be configured to receive video images of gestures 904 of user 902. The audio sensor may be configured to receive a voice command of user 902. A microphone sensor may be able to pick up various sounds associated with the assistant to allow maneuvering or diagnostic analysis of the automated personal assistant 900, in addition to voice commands.

Control system 502 of automated personal assistant 900 may be configured to determine actuator control commands 510 configured to control system 502. Control system 502 may be configured to determine actuator control commands 510 in accordance with sensor signals 508 of sensor 506. Automated personal assistant 900 is configured to transmit sensor signals 508 to control system 502. Classifier 514 of control system 502 may be configured to execute a gesture recognition algorithm to identify gesture 904 made by user 902, to determine actuator control commands 510, and to transmit the actuator control commands 510 to actuator 504. Classifier 514 may be configured to retrieve information from non-volatile storage in response to gesture 904 and to output the retrieved information in a form suitable for reception by user 902. In addition, the classifier 514 may be able to detect a sound according to an embodiment to assist in maneuvering.

FIG. 10 depicts a schematic diagram of control system 502 configured to control monitoring system 1000. Monitoring system 1000 may be configured to physically control access through door 1002. Sensor 506 may be configured to detect a scene that is relevant in deciding whether access is granted. Sensor 506 may be an optical sensor configured to generate and transmit image and/or video data. Such data may be used by control system 502 to detect a person's face.

Classifier 514 of control system 502 of monitoring system 1000 may be configured to interpret the image and/or video data by matching identities of known people stored in non-volatile storage 516, thereby determining an identity of a person. Classifier 514 may be configured to generate and an actuator control command 510 in response to the interpretation of the image and/or video data. Control system 502 is configured to transmit the actuator control command 510 to actuator 504. In this embodiment, actuator 504 may be configured to lock or unlock door 1002 in response to the actuator control command 510. In other embodiments, a non-physical, logical access control is also possible.

Monitoring system 1000 may also be a surveillance system. In such an embodiment, sensor 506 may be an optical sensor configured to detect a scene that is under surveillance and control system 502 is configured to control display 1004. Classifier 514 is configured to determine a classification of a scene, e.g. whether the scene detected by sensor 506 is suspicious. Control system 502 is configured to transmit an actuator control command 510 to display 1004 in response to the classification. Display 1004 may be configured to adjust the displayed content in response to the actuator control command 510. For instance, display 1004 may highlight an object or classify it to a class obtained by classifier 514. Utilizing an embodiment of the system disclosed, the surveillance system may identify such objects. Further, the classifier 514 can identify sounds that can detect certain events in a security setting, such as a package drop off, gun shot, etc.

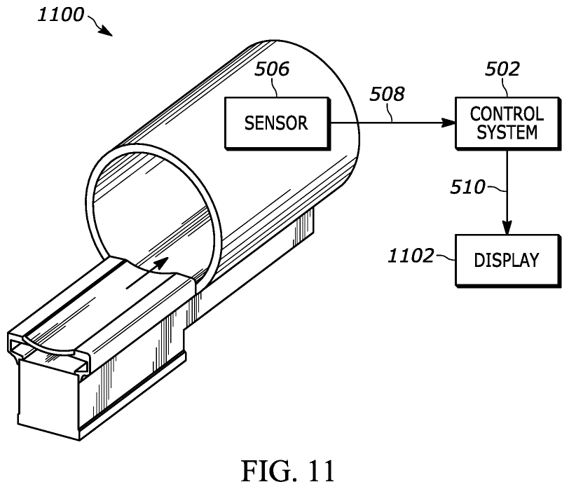

FIG. 11 depicts a schematic diagram of control system 502 configured to control imaging system 1100, for example an MRI apparatus, x-ray imaging apparatus or ultrasonic apparatus. Sensor 506 may, for example, be an imaging sensor. Classifier 514 may be configured to determine a classification of all or part of the sensed image. Classifier 514 may be configured to determine or select an actuator control command 510 in response to the classification obtained by the trained neural network. For example, classifier 514 may interpret a region of a sensed image to identify classification of a sensed image. In this case, actuator control command 510 may be determined or selected to cause display 1102 to display the imaging classify the MRI image, X-Ray image, or ultrasonic image. The classifier 514 may also be utilized to identify sounds emitted during a procedure or operation of the imaging system 1100.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A method of machine learning network, comprising:
(i) receiving one or more sound segments that includes one or more associated text labels indicating captions;
(ii) generating, utilizing a large language model of the machine learning network, one or more counterfactual captions associated with the one or more sound segments, wherein the one or more counterfactual captions are adversarial captions;
(iii) determining a factual loss utilizing the one or more audio segments and the one or more associated text labels;
(iv) determining an angle loss by adding a first loss and a second loss, wherein the first loss is associated with similarities of the one or more sound segments and the one or more associated text labels, and the second loss is associated with similarities of the one or more sound segments and the counterfactual captions;
(v) determining an aggregate loss by adding the factual loss and the angle loss;
(vi) updating parameters associated with an audio encoder or text encoder of the machine learning network;
(vii) in response to a variable associated with the machine learning network falling below a threshold repeating steps (i) thru (vi); and
(viii) in response to the variable associated with the machine learning network meeting the threshold, updating final parameters associated with the machine learning network.

2. The method of claim 1, wherein the at least one machine learning model includes a sound event detection model.

3. The method of claim 1, wherein parameters associated with the audio encoder are updated utilizing back-propagation during training.

4. The method of claim 1, wherein parameters associated with the text encoder are frozen during training.

5. The method of claim 1, wherein updating parameters includes updating parameters associated with both the audio encoder and the text encoder.

6. The method of claim 1, wherein the audio encoder is associated with one of at least CLAP, WAV2CLIP, AUDIO CLIP, PANN, YamNet.

7. The method of claim 1, wherein the counterfactual caption increases loss of the one or more sound segments as compared to the original caption.

8. The method of claim 1, wherein the similarities are cosine similarities.

9. The method of claim 1, wherein the variable is associated with a number of iterations.

10. The method of claim 1, wherein the variable is associated with the aggregate loss.

11. A system for training at least one machine learning model, the system comprising:
a processor; and
a memory including instructions that, when execute by the processor, cause the processor to:
(i) receive one or more sound segments that includes one or more associated text labels indicating captions;
(ii) generate, utilizing a large language model of a machine learning network, one or more counterfactual captions associated with the one or more sound segments, wherein the one or more counterfactual captions are adversarial captions;
(iii) determine a factual loss in response to a distance between the one or more audio segments and the one or more associated text labels;
(iv) determine an angle loss by adding a first loss and a second loss, wherein the first loss is associated with cosine similarities of the one or more sound segments and the one or more associated text labels, and the second loss is associated with cosine similarities of the one or more sound segments and the counterfactual captions;
(v) determine an aggregate loss by aggregating the factual loss and the angle loss;
(vi) update parameters associated with the machine learning network;
(vii) in response to a variable associated with the machine learning network falling below a threshold, repeating steps (i) thru (vii); and
(vii) in response to the variable associated with the machine learning network meeting the threshold and ranking the one or more sound segments, update final parameters associated with the machine learning network.

12. The system of claim 11, wherein the counterfactual caption is manually generated.

13. The system of claim 11, wherein the counterfactual caption is generated by a large language model.

14. The system of claim 11, wherein the machine learning network includes a zero-shot model.

15. The system of claim 11, wherein the rank is computed a sum of cosine similarities between all positive text embeddings and the one or more sound segments, minus cosine similarities between all counterfactual text embeddings and the one or more sound segments.

16. A method of machine learning network, comprising:
(i) receiving one or more sound segments and one or more associated text labels indicating captions associated with the sound segments;
(ii) generating, utilizing a large language model of the machine learning network, one or more counterfactual captions associated with the one or more sound segments, wherein the one or more counterfactual captions are adversarial captions;
(iii) determining a loss associated with the one or more sound segments, one or more associated text labels, and one or more counterfactual captions;
(vii) updating parameters associated with an audio encoder or text encoder of the machine learning network;
(vii) in response to a variable associated with the machine learning network falling below a threshold, repeating steps (i) thru (vii); and
(viii) in response to the variable associated with the machine learning network meeting the threshold and utilizing a ranking, updating final parameters associated with the machine learning network.

17. The method of claim 16, wherein the audio encoder is one of either a Pann encoder, Resnet encoder, or Mobile Net encoder.

18. The method of claim 16, wherein the machine learning network is associated with sound event detection.

19. The method of claim 16, wherein the text encoder is one of either a Bert encoder, Flan encoder, or T 5encoder.

20. The method of claim 16, wherein the machine learning network includes a zero-shot prompt.
